(19) United States
(12) Patent Application Publication
(10) Pub. No.: US 2005/0039561 A1
(43) Pub. Date: Feb. 24, 2005

(54) Motor-driven servo steering system for motor vehicles

(76) Inventor: Arthur Rupp, Huettlingen (DE)

Correspondence Address: KENYON & KENYON, ONE BROADWAY, NEW YORK, NY, 10004, US

(21) Appl. No.: 10/496,407

(22) PCT Filed: Nov. 14, 2002
(86) PCT No.: PCT/EP02/12761

(30) Foreign Application Priority Data
Nov. 24, 2001 (DE) 10157639.0

(51) Int. Cl. F16H 1/16

(52) U.S. Cl. 74/425; 74/388 PS; 74/DIG. 10

(57) ABSTRACT

A motor-driven, power-steering system for motor vehicles has at least one power-transmission element and a gear element in engagement with it. On its circumference provided for power transmission, the power-transmission element is formed by at least two materials in such a manner that, in normal operation, a non-metallic material engages with the gear element to transmit power.

The present invention relates to a motor-driven, power-steering system for motor vehicles according to the definition of the species in claim 1. The present invention also relates to a power-transmission element for such a steering system according to claim 9.

A gear unit of the species is known from DE 197 23 358 A1.

The overriding drive known from the document of the species is part of a motor-driven, power-steering system for a motor vehicle, where the steering movement of the driver is assisted by a motor. In this context, the steering wheel acts upon a first gear-unit input, and a servomotor acts upon a second gear-unit input of the overriding drive, which transmits the angles of rotation of the two gear-unit inputs to the gear-unit output in superposed form.

In the document of the species, and also in gear units known to be in practical use, the steering parts used for transmitting or assisting the direct mechanical power flow are predominantly made of metallic material. This ensures a constant margin of safety of the component over the service life. In the case of metallic materials, the degree of artificial aging due to environmental influences and the like is low. In this context, the high moment of inertia and the high weight of the components are disadvantageous. In addition, the anti-friction properties, as well as the damping characteristics and smooth running, do not meet the highest requirements and could be markedly improved by making steering parts used for assisting or transmitting the mechanical power flow, out of a non-metallic material. As has been shown, only non-metallic materials can be used for this, which, in regard to their mechanical properties, must have the characteristics of a metallic material, in order to prevent, in particular, a reduction in the margin of safety. In view of the costs and the validation, such a non-metallic material cannot be implemented in a useful manner. Therefore, the advantages, which can be produced by using a non-metallic material, may not be utilized.

G 83 14 824 Ul describes gear wheels and similarly toothed parts, in particular worm gears, which are made of a cast-iron material, and in which the tooth faces are provided with a sprayed-on coating of bronze or another material having good anti-friction properties. Such a method is expensive and complicated during manufacturing and cannot be usefully applied for today's gear units. This does not allow good damping characteristics, smooth running, a low moment of inertia, and a low weight, which is particularly important for the use of a gear unit in steering systems of motor vehicles.

DE 39 06 639 Al describes a gear unit for transmitting a comparatively low power, in particular in the case of auxiliary units of motor vehicles. In this context, at least one of the two gear elements are made of an elastic material, preferably plastic. In this connection, the tooth of the one gear element, as seen in the direction of the ongoing toothing, is larger than the tooth space of the other gear element. Therefore, the intermeshed teeth of the two gear elements engage with each other in an elastically biased manner, so that the usual tooth backlash is eliminated. In this context, it may also be provided that slit-type recesses, which start out from the so-called tooth space, extend in the radial direction into the disk of the gear wheel.

It is understandable that such a gear unit is only suitable for transmitting small amounts of power and is used, for example, in heater flaps or the like.

Therefore, the object of the present invention is to provide a gear unit, in particular an overriding drive for steering systems of motor vehicles, where the advantages of a non-metallic material, which is inexpensive to manufacture and simple to process, can be utilized without having to fear that the steering system will fail on account of a failure of the non-metallic material.

The object of the present invention is achieved by the characterizing features of claim 1. In this context, an advantageous power-transmission element is derived from the characterizing features of claim 9.

Since the power-transmission element is formed by at least two materials on its circumference provided for transmitting power, the advantages resulting from the non-metallic material may be combined with the advantages of a further material. In this context, the further material may be formed in such a manner that, in response to larger forces, in particular in the event of misuse, or in response to failure of the non-metallic material, the transmission of power is assumed by the further material. Therefore, the power flow is ensured by the further material. In normal operation, the non-metallic material is used for transmitting power, so that a low moment of inertia and a low weight may be realized.

Further advantageous characteristics, such as good anti-friction properties, damping characteristics, and smooth running may also be achieved with the aid of the non-metallic material.

Since the non-metallic material is safeguarded by a further material, the non-metallic material may be inexpensively manufactured and used in a simple manner. This obviates the use of an expensive, non-metallic material, which is brought up to the condition of a metallic material with regard to its mechanical properties, and may therefore not be used in a practical manner, in particular with regard to cost.

In addition, the present invention may provide for the non-metallic material to be situated in the center region of the circumference of the power-transmission element, and for the outer region adjacent to the center region of the circumference of the power-transmission element being made of a fatigue-resistant material having a high load-bearing capacity.

When the non-metallic material situated in the center region fails, then the adjacent outer region of the circumference becomes useful, so that operability is ensured over the entire service life, particularly in the case of misuse, as well. One does not even need to fear the breakdown of the steering system, when the non-metallic part of the power-transmission element fails. The positioning of the non-metallic material in the center region has proven to be particularly useful for the constructive variant, since, during normal operation, this allows the power-transmission element to only be engaged with the gear element in this region.

It has proved particularly advantageous to position the fatigue-resistant material having a high load-bearing capacity at the two outer regions adjacent to the center region. However, it is also conceivable to only position the fatigue-resistant material having a high load-bearing capacity, at one outer region, so that the other outer region is either made of the non-metallic material, as well, which also forms the center region or the center section, or a third material is used.

It is advantageous, when the non-metallic material is made of plastic.

In regard to the above-mentioned advantages and cost-effective use, it has proven particularly useful for the non-metallic material to take the form of plastic.

In one structural refinement of the present invention, it may also be provided that the fatigue-resistant material having a high load-bearing capacity be made of a hard, fiber-reinforced plastic and/or a metallic material, preferably steel.

As has been shown in trials, the fatigue-resistant material having a high load-bearing capacity may be implemented in a particularly advantageous manner, when it is made of steel. A steel construction ensures reliable power transmission over the entire service life of the gear unit.

An advantageous power-transmission element for transmitting a mechanical power flow, having gear teeth situated at the circumference, is derived from the characterizing part of claim 9.

Advantageous embodiments and further refinements of the present invention are yielded from the further dependent claims, and from the following, diagrammatically represented exemplary embodiment, in view of the drawing.

The figures show:

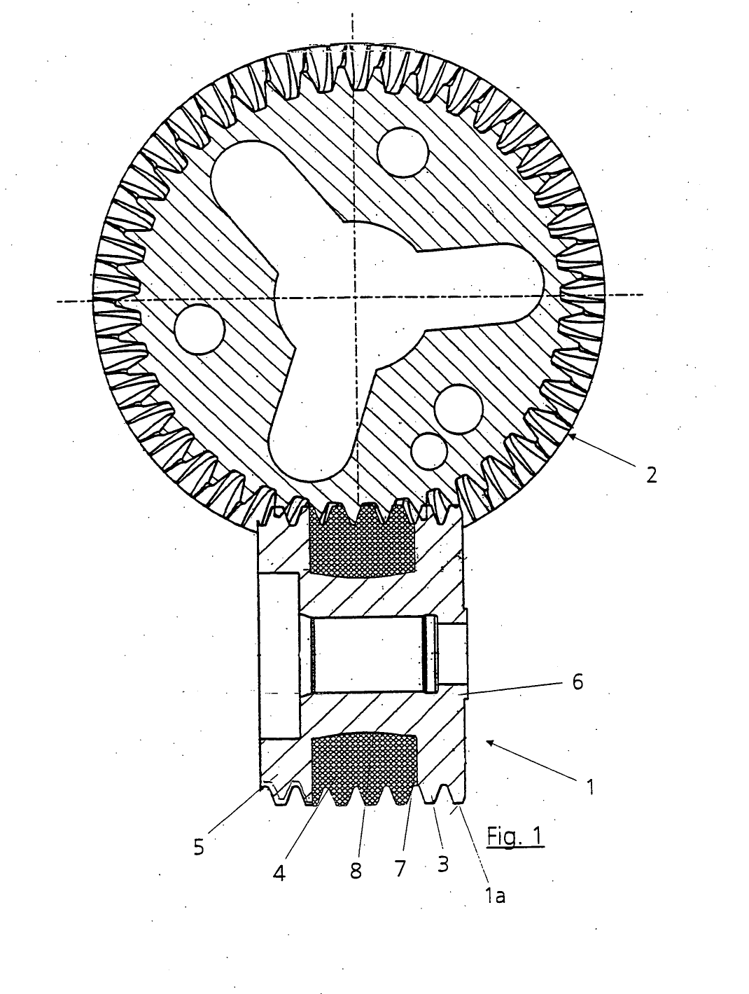

FIG. 1 a representation of a power-transmission element and a gear element engaged with it; and

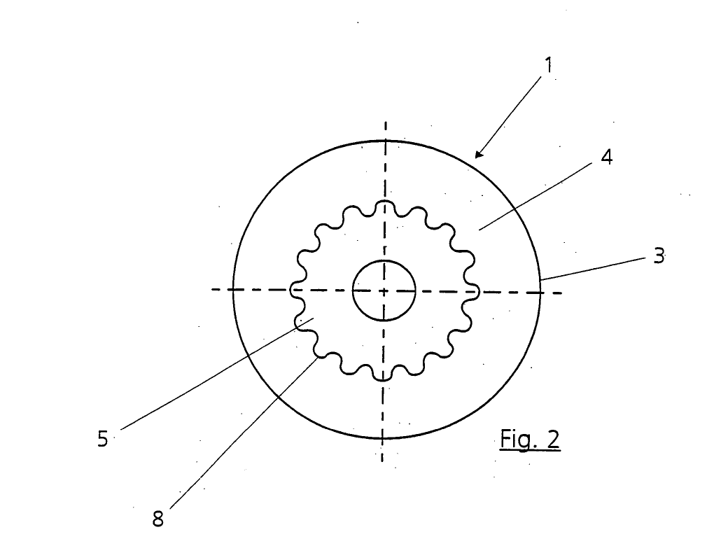

FIG. 2 a cross-section of a power-transmission element.

A motor-driven, power-steering system for motor vehicles, having an overriding drive, is sufficiently well-known, which is why it will not be discussed in more detail below. Only DE 197 23 358 Al is mentioned as an example of this.

FIG. 1 shows a power-transmission element 1 of an overriding drive for steering systems, the power-transmission element being engaged with a gear element 2. Of course, more than one power-transmission element 1 may also be provided in alternative embodiments. In the present exemplary embodiment, the power-transmission element takes the form of a worm 1 and the gear element takes the form of a worm gear 2.

Worm 1 has gear teeth 3 at its circumference for transmitting power. In this context, worm 1 is made of two different materials at circumference 1a. In the present exemplary embodiment, these are a non-metallic material made of plastic 4 and a fatigue-resistant material, which is made of steel 5 and has a high load-bearing capacity. Plastic 4 is situated in the center region of circumference 1a of worm 1, and steel 5 is situated at the outer regions of circumference 1a. As is apparent from FIG. 1, the transmission of power in normal operation is accomplished by plastic 4 situated in the center region of circumference 1a. The outer region made of steel 5 is only used and only takes over the transmission of power, when transmission forces are large, above all, in the case of misuse, and when the center region fails. Therefore, the transmission of power is ensured by the outer region made of steel 5.

Various plastics, such as polyamide, are suitable as plastic 4. In this context, the particular selection of the most suitable plastic may be adapted to the specific situation. Regardless of whether toothing 3 is made of plastic 4 or steel 5, it may have an identical geometry.

Of course, a different metallic material may also be used in place of steel 5. A hard, fiber-reinforced plastic is also conceivable in this case. It is only important that this material can absorb large transmission forces and ensures that the steering system functions reliably in the event of a failure of the center region.

Worm 1 represented in FIG. 1 essentially has a metallic base 6, which is made of steel 5 and has a recess 7 in the center region of circumference 1a; non-metallic material 4, in the present case plastic 4, being injected into the recess. Such a design of worm 1 has shown itself to be particularly suitable with regard to simple and inexpensive manufacturing.

As can be seen in FIG. 2, steel 5, i.e. base 6, may be connected to plastic 4 in a particularly advantageous manner, via mechanical inner toothing 8. Inner toothing 8 ensures a secure and reliable connection between steel 5 and plastic 4.

To this end, it is conceivable for worm 1 to initially be manufactured as a cylindrical blank having injected plastic 4, and to be made of steel 5 in the outer region of circumference 1a and plastic 4 in the center region. Toothing 3 may then be introduced with the aid of a well-known technique, such as machining.

As an alternative to this, it is also conceivable for toothing 3 in the outer region made of steel 5 to already be pre-machined, and for this diameter to be a little less than that of the subsequently introduced center region made of plastic 4, which is machined and consequently leveled after being introduced, in order to produce gear teeth 3.

As an alternative to the embodiment of worm 1 represented in FIG. 1, it may also be provided that plastic 4 introduced in the center region is only sprayed on, i.e. in the extreme case, it is only a type of coating. Various well-known coating methods may be used for this. However, the form shown in FIG. 1, in which plastic 4 extends deeply into base 6, i.e. into worm 1, is advantageous. Therefore, the advantages already mentioned may be achieved in a particularly effective manner.

Of course, the shown refinement is not restricted to the mentioned exemplary embodiment. On the contrary, several options for use are apparent to one skilled in the art.

Reference Numerals

1 power-transmission element; worm
1a circumference
2 gear element; worm gear
3 gear teeth
4 non-metallic material; plastic
5 fatigue-resistant material having a high load-bearing
capacity; steel
6 base
7 recess
8 inner toothing

1-9. (Canceled).

10. A gear unit for a motor-driven, motor-vehicle power-steering system, comprising:
a gear element; and
at least one power-transmission element, the gear element in engagement with the power-transmission element, a circumference of the power-transmission element configured to transmit power formed of at least two materials, a portion of the circumference formed of a non-metallic material arranged to engage with the gear element in normal operation to transmit power, the power-transmission element largely formed of a metallic material, the non-metallic material one of (a) sprayed and (b) injected onto the metallic material, the portion of the circumference formed of the non-metallic material arranged in a center region of the circumference of the power-transmission element, the metallic material connected to the portion of the circumference formed of the non-metallic material by an inner toothing.

11. The gear unit according to claim 10, wherein the metallic material is not engaged with the gear element during the normal operation includes a fatigue-resistant material having a high load-bearing capacity.

12. The gear unit according to claim 11, wherein at least one outer region of the circumference adjacent to the center region of the circumference is formed of the fatigue-resistant material having the high load-bearing capacity.

13. The gear unit according to claim 10, wherein the power-transmission element is arranged as a worm, and the gear element is arranged as a worm gear.

14. A gear unit for a motor-driven, motor-vehicle power-steering system, comprising:
a gear element; and
at least one power-transmission element, the gear element in engagement with the power-transmission element, the power-transmission element, a circumference of the power-transmission element configured to transmit power formed of at least two materials, a portion of the circumference formed of a non-metallic, plastic material arranged to engage with the gear element in normal operation to transmit power, the portion of the circumference formed of the non-metallic, plastic material arranged in a center region of the circumference of the power-transmission element, another material of the power-transmission element being a fatigue-resistant, hard, fiber-reinforced plastic material having a high load-bearing capacity.

15. A motor-driven power-steering system for a motor vehicle, comprising:
a gear unit including:
a gear element; and
at least one power-transmission element, the gear element in engagement with the power-transmission element, a circumference of the power-transmission element configured to transmit power formed of at least two materials, a portion of the circumference formed of a non-metallic material arranged to engage with the gear element in normal operation to transmit power, the power-transmission element largely formed of a metallic material, the non-metallic material one of (a) sprayed and (b) injected onto the metallic material, the portion of the circumference formed of the non-metallic material arranged in a center region of the circumference of the power-transmission element, the metallic material connected to the portion of the circumference formed of the non-metallic material by an inner toothing.

16. A motor-driven power-steering system for a motor vehicle, comprising:
a gear unit including:
a gear element; and
at least one power-transmission element, the gear element in engagement with the power-transmission element, the power-transmission element, a circumference of the power-transmission element configured to transmit power formed of at least two materials, a portion of the circumference formed of a non-metallic, plastic material arranged to engage with the gear element in normal operation to transmit power, the portion of the circumference formed of the non-metallic, plastic material arranged in a center region of the circumference of the power-transmission element, another material of the power-transmission element being a fatigue-resistant, hard, fiber-reinforced plastic material having a high load-bearing capacity.
